(19) United States
(12) Patent Application Publication
(10) Pub. No.: US 2011/0047227 A1
(43) Pub. Date: Feb. 24, 2011

(54) MESSAGE-SERVICE AUDIENCE RESPONSE

(75) Inventors: Dave W. Arthurs, Columbiana, OH (US); Don R. Arthurs, Leetonia, OH (US); Kevin Adkins, Akron, OH (US)

Correspondence Address: BENESCH, FRIEDLANDER, COPLAN & ARONOFF LLP;ATTN: IP DEPARTMENT DOCKET CLERK, 200 PUBLIC SQUARE, SUITE 2300, CLEVELAND, OH, 44114-2378, US

(73) Assignee: TURNING TECHNOLOGIES, LLC, Youngstown, OH (US)

(21) Appl. No.: 12/815,656

(22) Filed: Jun. 15, 2010

Related U.S. Application Data
(63) Continuation-in-part of application No. 12/543,280, filed on Aug. 18, 2009.

(51) Int. Cl. G06F 15/16

(52) U.S. Cl. 709/206; 709/227

(57) ABSTRACT

A communication device may include a message-service communication logic configured to capture an incoming message-service message, where the message-service communication logic is further configured to compare at least a portion of the incoming message-service message to indicia to determine whether the incoming message-service message includes a user response to a polling question, and where the message-service communication logic is further configured to extract the user response from the message-service message. The communication device may further include a server communication logic configured to communicate to an audience response server response data including the user response.

### CROSS REFERENCE TO RELATED APPLICATIONS

This application is a continuation-in-part of U.S. Nonprovisional patent application Ser. No. 12/543,280 filed on Aug. 18, 2009, which is incorporated herein by reference.

### FIELD OF THE INVENTION

The present application relates to an audience response system. More particularly, the present application relates to devices and methods for implementing an audience response system capable of receiving audience responses via message-service messages.

### BACKGROUND

Prior audience response systems have been employed to retrieve (or receive) audience responses from a group of users at a central location. Such systems may be used in classroom settings, corporate meetings, or in other gatherings. These systems may include a base unit or host computer running the audience response session and a plurality of response devices.

Other audience response systems have been employed to retrieve (or receive) audience responses where the users may be non-colocated, that is the response devices are located at different physical locations from each other or from a base unit or host computer running the audience response session. Some of these non-colocated response devices employ direct physical connections to the base unit or host computer. Others employ persistent connections using routing applications or virtual response devices. Other non-colocated response devices require the leasing of telephone numbers or short codes from cellular service providers.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates one embodiment of an audience response system incorporating a communication device capable of communicating with other communication devices via message-service and with an audience response server via computer communication.

FIG. 2 illustrates a block diagram of an audience response system incorporating a communication device capable of communicating with other communication devices via message-service and with an audience response server via computer communication.

FIG. 3 illustrates a block diagram of an audience response system incorporating a communication device capable of communicating with other communication devices via message-service and with an audience response server via computer communication.

FIG. 4 illustrates a flow chart showing an example method for an audience response system incorporating a communication device capable of communicating with other communication devices via message-service and with an audience response server via computer communication.

### DETAILED DESCRIPTION

The following includes definitions of selected terms employed herein. The definitions include various examples, forms, or both of components that fall within the scope of a term and that may be used for implementation. The examples are not intended to be limiting. Both singular and plural forms of terms may be within the definitions.

“Computer communication,” as used herein, refers to a communication between two or more computing devices (e.g., computer, personal digital assistant, cellular telephone, and so on) and can be, for example, a network transfer, a file transfer, an applet transfer, an email, a hypertext transfer protocol (HTTP) transfer, and so on. A computer communication can occur across, for example, a wireless system (e.g., IEEE 802.11 (Wi-Fi), IEEE 802.15, and so on), an Ethernet system (e.g., IEEE 802.3, and so on), a token ring system (e.g., IEEE 802.5, and so on), a local area network (LAN), a wide area network (WAN), a point-to-point system, a circuit switching system, a packet switching system, a serial bus, a universal serial bus (USB), firewire (IEEE 1394), Bluetooth (IEEE 802.15.1), Zigbee (IEEE 802.15.4) combinations thereof, and so on.

“Message-Service” or “MS,” as used herein, refers to messaging services included in telecommunication networks (e.g. Global System for Mobile Communications (GSM) networks, CDMA networks, satellite networks, landline networks, and so on) that allow devices to send and receive relatively short messages using standardized communications protocols. MS includes Short Message Service (SMS), Enhanced Message Service (EMS), Multimedia Message Service (MMS), and so on.

“Computer-readable medium,” as used herein, refers to a medium that participates in directly or indirectly providing instructions or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory and the like. Transmission media may include coaxial cables, copper wire, fiber optic cables, and the like. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, and other media from which a computer, a processor or other electronic device can read.

“Logic,” as used herein, includes but is not limited to hardware, firmware, software or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

“Signal,” as used herein, includes but is not limited to one or more electrical or optical signals, analog or digital signals, data, one or more computer or processor instructions, messages, a bit or bit stream, or other means that can be received, transmitted or detected.

“Software,” as used herein, includes but is not limited to, one or more computer or processor instructions that can be read, interpreted, compiled, or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in serial, parallel, massively parallel and other manners.

Suitable software for implementing the various components of the example systems and methods described herein may be produced using programming languages and tools like Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium as defined previously. Other forms of software may include forms that may be transmitted to a recipient over a network or other communication medium. Thus, in one example, a computer-readable medium has a form of the communication medium as the software/firmware is downloaded from a web server to a user. In another example, the computer-readable medium has a form of the storage medium as the software/firmware is maintained on a web server. Other forms may also be used.

“User,” as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. It has proven convenient at times, principally for reasons of common usage, to refer to these physical quantities as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

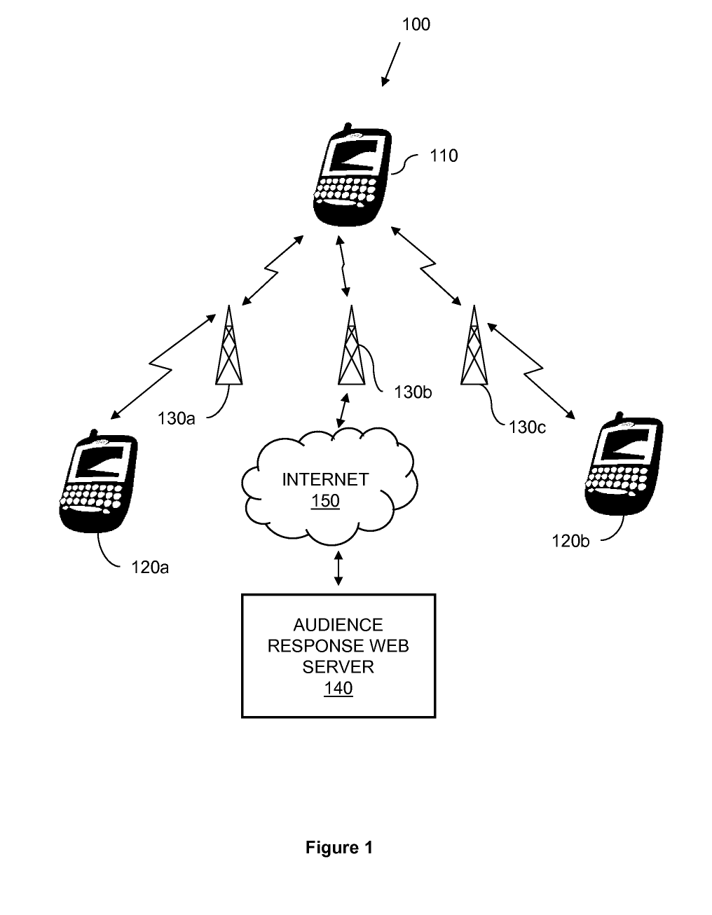

FIG. 1 illustrates an audience response system 100 incorporating a communication device 110 capable of communicating with other communication devices 120a-b via message-service (MS) and with an audience response server 140 via computer communication. In the illustrated embodiment, communication device 110 is shown as a smart phone. In other embodiments, communication device 110 may be one of various mobile devices known in the art (e.g. wireless telephone, cellular telephone, PDA, smart phone, laptop computer, entertainment device, media player, and so on) enabled with both MS (e.g. short messaging service (SMS), multimedia messaging service (MMS), and so on) and computer communication (e.g. network, internet and so on). In other embodiments, communication device 110 may be one of various non-mobile devices known in the art (e.g. landline telephone, desktop computer, and so on).

In the illustrated embodiment, communication device 110 is enabled to communicate with MS enabled devices 120a-b via MS communication. MS communication between communication device 110 and MS enabled devices 120a-b may take place via one or more wireless communications networks 130a-c.

In one embodiment, communication device 110 is further enabled to communicate with an audience response server 140 via computer communication such as network communication. In the illustrated embodiment, communication device 110 communicates with audience response server 140 via the internet 150. Communication device 110 interacts with the internet 150 and with audience response server 140 via wireless communication network 130b. In this embodiment, audience response server 140 may run one or multiple audience response sessions in which MS enabled devices 120a-b may participate through MS communication with communication device 110 as described below.

In one embodiment, audience response server 140 may be implemented in a computer or group of computers separate from a computer running the audience response sessions. In another embodiment, audience response server 140 may be implemented in the same computer or group of computers running the audience response sessions. Audience response server 140 may also be implemented as part of the audience response application, and thus communication device 110 may communicate directly with the computer or group of computers running the audience response sessions via computer communication (e.g. Wi-Fi, Bluetooth, USB, and so on).

In one embodiment, audience response server 140 may be embodied within communication device 110. In one embodiment, communication device 110 may also run the audience response sessions such that communication device 110 may host the audience response sessions and MS enabled devices 120a-b may, for example, respond to questions presented in the audience response sessions via MS communication with communication device 110.

In the illustrated embodiment, audience response system 100 incorporates one communication device 110. In other embodiments, audience response system 100 may include multiple communication devices (now shown) each enabled to communicate with audience response server 140. The multiple communication devices may participate in one audience response session together or the multiple communication devices may participate in different audience response sessions.

In the illustrated embodiment, MS enabled devices 120a-b are shown as smart phones. In other embodiments, each of MS enabled devices 120a-b may be one of various MS enabled devices known in the art (e.g. telephone, wireless telephone, cellular telephone, PDA, smart phone, desktop computer, laptop computer, entertainment device, media player, and so on).

In one embodiment, audience response server 140 runs one or more audience response sessions. In one embodiment, audience response server 140 or another computer or device may look up a list of authorized users or participants in one or more audience response sessions. In another embodiment, a user or participant may join an audience response session after entering a passcode or complying with some other means of identification. Appearing on the list or entering the passcode may identify a particular audience response session in which the user is authorized to participate or listed as a participant.

During an audience response session, audience response server 140 poses one or more polling questions to which a user at MS enabled devices 120a-b may issue responses. Users of MS enabled devices 120a-b may enter responses to the polling questions via interfaces (e.g. keyboards, touch screens, and so on) in MS enabled devices 120a-b into MS messages. MS enabled devices 120a-b may then transmit the MS messages to communication device 110. Communication device 110 may capture received MS messages and determine whether the received MS messages include user responses to the polling question. If the received MS messages include user responses to the polling question, communication device 110 extracts the user responses from the MS messages. Communication device 110 may then communicate the user responses to audience response server 140.

In one embodiment, communication device 110 may receive question data including polling questions from audience response server 140. Communication device 110 may then generate MS messages including the polling questions and transmit the polling questions to one or more of MS enabled devices 120a-b via the MS messages.

Communication device 110 may obtain the question data from an interface exposed by audience response server 140. Via the Internet 150, audience response server 140 may expose an interface to communication device 110. Communication device 110 may discover the exposed interface through the Internet 150. For example, audience response server 140 may expose polling interfaces reflecting polling sessions. These polling interfaces may be exposed as web services or similar technologies. Communication device 110 may use web services to gain access to polling sessions. As a response to a request from communication device 110, audience response server 140 may return question data containing the polling question.

Exposing interfaces may be accomplished through the use of software designed to support interoperable machine-to-machine interaction over a network (e.g. web services, Object Management Group's (OMG) Common Object Request Broker Architecture (CORBA), Microsoft's Distributed Component Object Model (DCOM), Sun Microsystems's Java/Remote Method Invocation (RMI), and so on). Exposed interfaces may be described in a machine-processable format such as an XML-based language (e.g. Web Services Description Language (WSDL) for web services and so on). Communication device 110 may interact with audience response server 140 using a protocol for exchanging structured information messages (e.g. Simple Object Access Protocol (SOAP) for web services and so on).

In one embodiment, communication device 110 may receive aggregated response information from audience response server 140 via the internet 150. Communication device 110 may then transmit the aggregated response information to one or more of MS enabled devices 120a-b via MS messages. For example, via the internet 150, communication device 110 may obtain from audience response server 140 results data representing aggregated responses to the polling questions. Communication device 110 may then generate MS messages including the aggregated responses and transmit the aggregated responses to one or more of MS enabled devices 120a-b via the MS messages. Communication device 110 may obtain the results data via web services or similar technology from an interface exposed by audience response server 140.

In one embodiment, the system 100 tracks which user responses correspond to a user or participant. The system may correlate users and devices based on the devices' telephone numbers, electronic serial numbers, and so on. Based on this information, the system may screen participants and include or exclude participants from a complete session or from a polling question. Based on the same information, the system may communicate back to a user or participant individualized information regarding the user or participant's answer. For example, communications device 110 may generate MS messages including the aggregated responses to the polling question together with the particular user's response to the polling question. In another example, where a user enters an invalid response (e.g. response was outside of range, too long a response, numeric response when alpha was expected, alpha response where numeric was expected, and so on) during polling, the communication device 110 may generate an MS message including a message indicating to the user that his response was invalid.

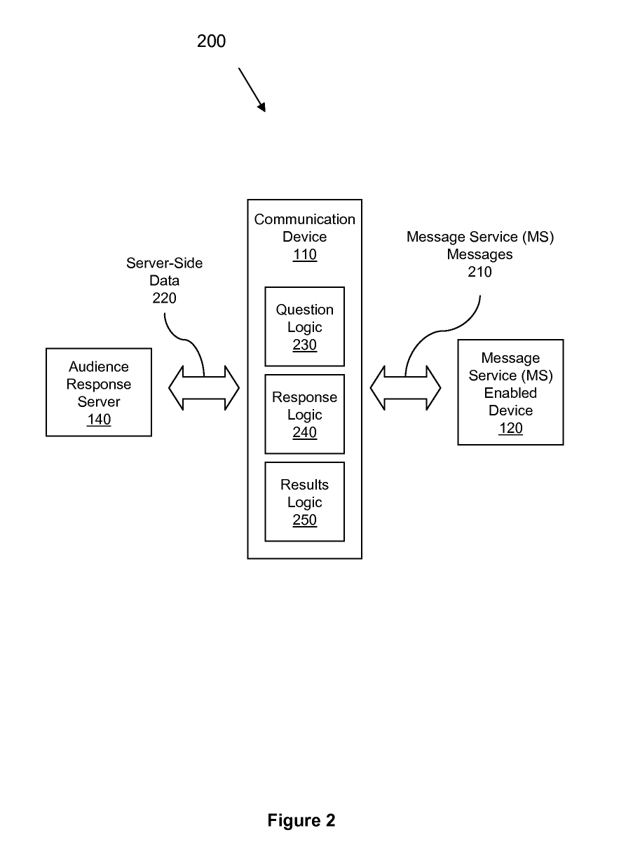

FIG. 2 illustrates a block diagram of an audience response system 200 incorporating a communication device 110. In the illustrated embodiment, communication device 110 may exchange MS messages 210 with MS enabled device 120. Communication device 110 may also exchange server-side data 220 with audience response server 140. MS messages 210 may include question MS messages, response MS messages, or results MS messages. Server-side data 220 may include question data, response data, or results data.

In one embodiment, communication device 110 executes software that by itself or in combination with other software or hardware embodies a set of logics. This software may take the form of an application or combination of applications that may be factory installed in communication device 110, or installed at a later time.

In one embodiment, communication device 110 includes a question logic 230. During an audience response session, question logic 230 may receive question data representing a polling question. Question logic 230 may generate a question MS message including the polling question. Communication device 110 communicates the question MS message to MS enabled device 120. A user at MS enabled device 120 may choose to respond to the polling question by entering a response and sending a response MS message including the user's response to the polling question to communication device 110.

In one embodiment, communication device 110 includes a response logic 240. Response logic 240 may capture incoming MS messages received by communication device 110 including the response MS message received from MS enabled device 120. Response logic 240 may then determine which, if any, of the incoming MS messages includes user responses to the polling question. In one embodiment, response logic 240 determines whether an incoming MS message includes a user response to the polling question by comparing the incoming MS message to a set of predetermined criteria to identify whether the contents of the incoming MS message include a user response to the polling question. The predetermined criteria may include indicia such as metadata and the like that would identify an incoming MS message as a response MS message.

If response logic 240 determines that an incoming MS message does not include a user response to the polling question (i.e. the incoming MS message is not a response MS message), response logic 240 may release the incoming MS message to an MS message inbox to which incoming MS messages may have been delivered if communication device 110 had not captured the incoming MS message. In one embodiment, communication device 110 is specifically dedicated to audience response applications. In this embodiment, if response logic 240 determines that an incoming MS message does not include a user response to the polling question (i.e. the incoming MS message is not a response MS message), response logic 240 may delete the incoming MS message. If response logic 240 determines that an incoming MS message includes a user response to the polling question (i.e. the incoming MS message is a response MS message), response logic 240 may extract the user response from the response MS message.

Communication device 110 may then communicate response data including the user response to audience response server 140. Audience response server 140 may in turn aggregate the responses to the polling question received from various response devices. Aggregated responses may include individual users' responses to the audience response questions or they may include group answers represented as percentages per multiple choice answer, and so on. Aggregated responses may be represented in number format, in graphical format, and so on. Graphical format may include bar graphs, pie bars, and so on. Audience response server 140 may communicate to communication device 110 results data incorporating the aggregated responses to the polling question. Communication device 110 may receive the aggregated answers in one format and convert them to a different format before communicating them or communication device 110 may communicate the aggregated answers in the same format as it received them.

In one embodiment, communication device 110 includes results logic 250. Results logic 250 may receive from audience response server 140 results data representing the aggregated responses to the polling question. Results logic 250 may also generate a results MS message including the aggregated responses to the polling question. Communication device 110 may then communicate the results MS message to MS enabled device 120. A user at MS enabled device 120 may then see or hear the aggregated responses to the polling question.

In one embodiment, audience response system 200 includes an identification logic (not shown). The identification logic may be configured to look up a list of authorized users or participants of one or more audience response sessions. In another embodiment, a user or participant may join an audience response session after entering a passcode or complying with some other means of identification required by the identification logic. Appearing on the list or entering the passcode may identify a particular audience response session in which the user is authorized to participate or listed as a participant. In another embodiment, the system may correlate users and devices based on the devices' telephone numbers, electronic serial numbers, and so on. Based on this information, the system may screen participants and include or exclude participants from a complete session or from a polling question. Based on the same information, the system may communicate back to a user or participant individualized information regarding the user or participant's answer.

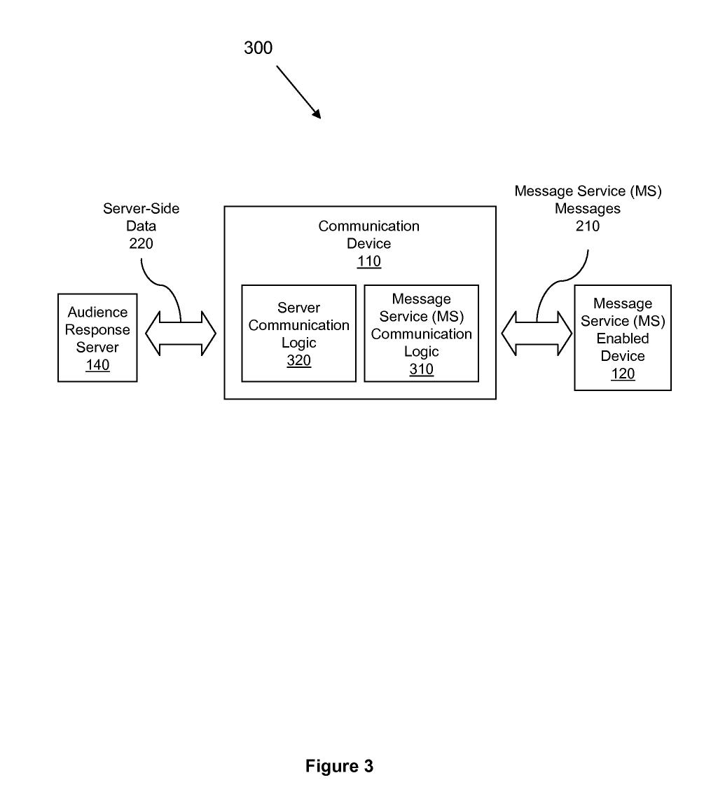

FIG. 3 illustrates a block diagram of an audience response system 300 including a communication device 110. In the illustrated embodiment, communication device 110 includes MS communications logic 310 and server communication logic 320. Communication device 110 exchanges MS messages 210 with MS enabled device 120 and server-side data 220 with audience response server 140. MS messages 210 may include question MS messages, response MS messages, or results MS messages. Server-side data 220 may include question data, response data, or results data.

In one embodiment, server communication logic 320 is configured to obtain server-side question data representing a polling question from audience response server 140. Server communication logic 320 is in communication with MS communication logic 310. MS communication logic 310 may then generate a question MS message including the polling question. Server communication logic 320 may receive the question data in one format and communication device 110 may convert it to a different format before MS communication logic 310 generates the question MS message, or MS communication logic 310 may generate the question MS message including the polling question in the same format as received from audience response server 140. Communication device 110 may then communicate the question MS message to MS enabled device 120. A user at MS enabled device 120 may see or hear the polling question from the question MS message and reply with a response MS message including the user's response to the polling question.

MS communication logic 310 may capture an incoming MS message from MS enabled device 120 and compare at least a portion of the incoming MS message to response indicia to determine whether the incoming MS message includes a user response to a polling question. If MS communication logic 310 determines that the incoming MS message does not include a user response to the polling question (i.e. the incoming MS message is not a response MS message), MS communication logic 310 may release the incoming MS message to an MS message inbox to which the incoming MS message may have been delivered if communication device 110 had not captured it. If MS communication logic 310 determines that the incoming MS message includes a user response to the polling question (i.e. the incoming MS message is a response MS message), MS communication logic 310 may extract the user response from the response MS message.

Communication device 110 may then communicate response data including the user response to the polling question to audience response server 140. Audience response server 140 may in turn aggregate the responses to the polling question received from various response devices. Aggregated responses may include individual users' responses to the audience response questions or they may include group answers represented as percentages per multiple choice answer, and so on. Aggregated responses may be presented in number format, in graphical format, and so on. Graphical format may include bar graphs, pie bars, and so on.

In one embodiment, audience response server 140 may communicate to communication device 110 results data representing the aggregated responses to the polling question. Server communication logic 320 obtains the results data representing aggregated responses to the polling question from audience response server 140.

In one embodiment, MS communication logic 310 generates an outgoing MS message including the aggregated responses to the polling question. Communication device 110 may then communicate the outgoing MS message to MS enabled device 120. A user at MS enabled device 120 may then see or hear the aggregated responses to the polling question. Server communication logic 320 may receive the aggregated answers in one format and communication device 110 may convert the aggregated answers to a different format before MS communication logic 310 generates the outgoing MS message or MS communication logic 310 may generate the outgoing MS message including the aggregated answers in the same format as received from audience response server 140.

In one embodiment, audience response system 300 includes an identification logic (not shown). The identification logic may be configured to look up a list of authorized users or participants of one or more audience response sessions. In another embodiment, a user or participant may join an audience response session after entering a passcode or complying with some other means of identification required by the identification logic. Appearing on the list or entering the passcode may identify a particular audience response session in which the user is authorized to participate or listed as a participant. In another embodiment, the system may correlate users and devices based on the devices' telephone numbers, electronic serial numbers, and so on. Based on this information, the system may screen participants and include or exclude participants from a complete session or from a polling question. Based on the same information, the system may communicate back to a user or participant individualized information regarding the user or participant's answer.

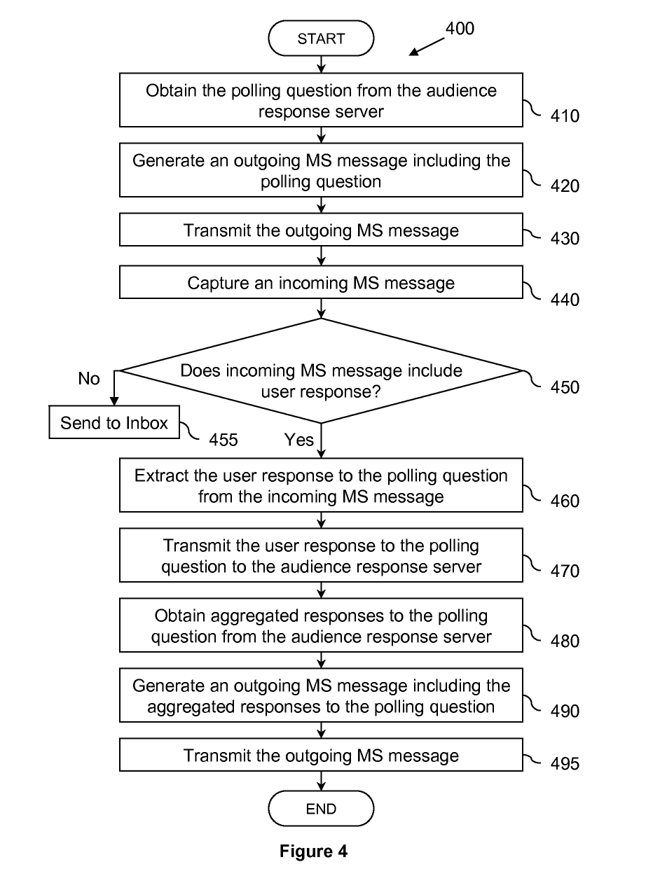

Example methods may be better appreciated with reference to the flow diagram of FIG. 4. While for purposes of simplicity of explanation, the illustrated methodologies are shown and described as a series of blocks, it is to be appreciated that the methodologies are not limited by the order of the blocks, as some blocks can occur in different orders, concurrently with other blocks from that shown and described or both. Moreover, less than all the illustrated blocks may be required to implement an example methodology. Furthermore, additional, alternative methodologies, or both can employ additional blocks not illustrated.

In the flow diagram, blocks denote “processing blocks” that may be implemented with logic. The processing blocks may represent a method step, an apparatus element for performing the method step or both. A flow diagram does not depict syntax for any particular programming language, methodology, or style (e.g., procedural, object-oriented, and so on). Rather, a flow diagram illustrates functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in sequences different from those shown. Additionally, multiple blocks may be combined into one or a single block may be separated into multiple blocks. It will also be appreciated that the processes may be implemented using various programming approaches like machine language, procedural, object oriented or artificial intelligence techniques.

In one example, methodologies are implemented as processor executable instructions or operations provided on a computer-readable medium. Thus, in one example, a computer-readable medium may store processor executable instructions operable to perform a method that includes one or more of the methods illustrated in FIG. 4.

While FIG. 4 illustrates various actions occurring in serial, it is to be appreciated that various actions illustrated in the figure could occur substantially in parallel. While a number of processes are described, it is to be appreciated that a greater or lesser number of processes could be employed and that lightweight processes, regular processes, threads, and other approaches could be employed. It is to be appreciated that other example methods may, in some cases, also include actions that occur substantially in parallel.

FIG. 4 illustrates a flow chart showing an example method 400 for a communication device (such as communication device 110) to participate in an audience response polling session running in an audience response server. At 410, the communication device obtains question data representing a polling question from the audience response server. In one embodiment, obtaining question data includes obtaining the question data from an interface exposed by the audience response server. At 420, the communication device generates an outgoing MS message including the polling question. At 430, the communication device transmits the outgoing MS message to a second communication device.

At 440, the communication device captures an incoming MS message from the second communication device. At 450, the communication device determines whether the incoming MS message includes a user response to the polling question. In one embodiment, determining includes comparing the incoming MS message to a set of predetermined criteria. At 455, if the communication device determines that the incoming MS message does not include a user response to the polling question, (i.e. the incoming MS message is not a response MS message), the incoming MS message may be released to an inbox. In an alternative embodiment, where the communication device is specifically dedicated to audience response applications, if the communication device determines that the incoming MS message does not include a user response to the polling question (i.e. the incoming MS message is not a response MS message), the incoming MS message may be deleted. If communication device determines that the incoming MS message includes a user response to the polling question (i.e. the incoming MS message is a response MS message), at 460, the communication device extracts the user response to the polling question from the incoming MS message. At 470, the communication device transmits data including the user response to the polling question to the audience response server running the audience response polling session.

At 480, the communication device obtains results data representing aggregated responses to the polling question from the audience response server. In one embodiment, obtaining results data includes obtaining the results data from an interface exposed by the audience response server. At 490, the communication device generates an outgoing MS message including the aggregated responses to the polling question. At 495, the communication device transmits the outgoing MS message to the second communication device.

In one embodiment, the method 400 includes identifying users or participants in the audience response session (not shown). In one embodiment, a device in the system may look up a list of authorized users or participants of one or more audience response sessions. In another embodiment, a user or participant may join an audience response session after entering a passcode or complying with some other means of identification. Appearing on the list or entering the passcode may identify a particular audience response session in which the user is authorized to participate or listed as a participant. In another embodiment, the method may correlate users and devices based on the devices' telephone numbers, electronic serial numbers, and so on. Based on this information, the method may screen participants and include or exclude participants from a complete session or from a polling question. Based on the same information, the method may communicate back to a user or participant individualized information regarding the user or participant's answer.

While example systems, methods, and so on, have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. An article of manufacture embodied in a computer-readable medium, the article of manufacture comprising:
a response logic configured to capture a message-service message from at least one message-service enabled device,
where the response logic is further configured to determine whether the message-service message includes a user response to a polling question,
where the response logic is further configured to extract the user response to the polling question from the message-service message, and
where the response logic is further configured to communicate response data representing the user response to the polling question.

2. The article of manufacture of claim 1, further comprising:
a question logic configured to receive question data representing the polling question, where the question logic is further configured to generate a question message-service message including the polling question to be transmitted to the at least one message-service enabled device.

3. The article of manufacture of claim 1, further comprising:
a results logic configured to receive results data representing aggregated responses to the polling question, where the results logic is further configured to generate a results message-service message including the aggregated responses to the polling question to be transmitted to the at least one message-service enabled device.

4. The article of manufacture of claim 3, where the results logic is configured to generate a message-service message indicating to a user that the user response was invalid

5. A communication device comprising:
a message-service communication logic configured to capture an incoming message-service message,
where the message-service communication logic is further configured to compare at least a portion of the incoming message-service message to indicia to determine whether the incoming message-service message includes a user response to a polling question, and
where the message-service communication logic is further configured to extract the user response from the message-service message; and
a server communication logic in communication with the message-service communication logic and configured to communicate response data including the user response.

6. The communication device of claim 5, where the server communication logic is further configured to obtain question data representing the polling question, and where the message-service communication logic is further configured to generate an outgoing message-service message including the polling question.

7. The communication device of claim 6, where the server communication logic is configured to obtain results data representing aggregated responses to the polling question, and where the message-service communication logic is configured to generate an outgoing message-service message including at least one of the aggregated responses to the polling question and an error message.

8. The communication device of claim 7, where the server communication logic is configured to obtain the question data and the results data from an interface exposed by an audience response server.

9. An audience response system comprising:
an audience response server configured to run an audience response session including at least one polling question;
at least two message-service enabled devices including a first message-service enabled device and a second message-service enabled device,
where the first message-service enabled device is configured to transmit a message-service message, the message-service message including a response to the at least one polling question,
where the second message-service enabled device is configured to capture the message-service message,
where the second message-service enabled device is further configured to extract the response to the at least one polling question from the message-service message, and
where the second message-service enabled device is also configured to cause transmission to the audience response server of response data representing the response to the at least one polling question during the audience response session.

10. The audience response system of claim 9, where the second message-service enabled device is configured to determine whether the message-service message includes the response to the at least one polling question.

11. The audience response system of claim 9, where the second message-service enabled device is configured to obtain from the audience response server question data representing the at least one polling question, and where the second message-service enabled device is configured to generate a question message-service message including the at least one polling question to be transmitted to the first message-service enabled device.

12. The audience response system of claim 11, where the second message-service enabled device is configured to obtain from the audience response server results data representing aggregated responses to the at least one polling question, where the second message-service enabled device is configured to generate a results message-service message including the aggregated responses to be transmitted to the first message-service enabled device.

13. The audience response system of claim 12, where the second message-service enabled device is configured to obtain the question data and the results data from an interface exposed by the audience response server.

14. The audience response system of claim 9, where the audience response server is implemented within the second message-service enabled device.

15. The audience response system of claim 9, where at least one of the audience response server and the second message-service enabled device is configured to correlate users and devices and to extract or cause transmission of response data representing the user's response to the at least one polling question based on the device.

16. The method of claim 9, where at least one of the audience response server and the second message-service enabled device is configured to communicate to the first message-service enabled device individualized information regarding the user response to the polling question.

17. A method performed by a communication device during an audience response polling session, the method comprising:
capturing an incoming message-service message received by the communication device;
determining whether the incoming message-service message includes a user response to a polling question associated with the audience response polling session;
obtaining the user response from the incoming message-service message; and
transmitting data including the user response to an audience response server running the audience response polling session.

18. The method of claim 17, where the determining includes comparing the incoming message-service message to a set of predetermined criteria.

19. The method of claim 17 further comprising:
obtaining from the audience response server question data representing the polling question;
generating an outgoing message-service message including the polling question; and
transmitting the outgoing message-service message.

20. The method of claim 19, where the obtaining question data includes obtaining the question data from an interface exposed by the audience response server.

21. The method of claim 17 further comprising:
obtaining results data representing aggregated responses to the polling question from the audience response server;
generating an outgoing message-service message including the aggregated responses to the polling question; and
transmitting the outgoing message-service message.

22. The method of claim 21, where the obtaining results data includes obtaining the results data from an interface exposed by the audience response server.

23. The method of claim 17, where the incoming message-service message is of a type selected from the group consisting of a short messaging service (SMS) message and multimedia messaging service (MMS).

24. The method of claim 17, where the audience response server is implemented within the communication device.
